(19) United States
(12) Patent Application Publication
(10) Pub. No.: US 2004/0118113 A1
(43) Pub. Date: Jun. 24, 2004

(54) Torque converter

(76) Inventors: Takao Fukunaga, Yawata-shi (JP); Tomohiro Tasaka, Kawanishi-shi (JP)

Correspondence Address: SHINJYU GLOBAL IP COUNSELORS, LLP, 1233 20TH STREET, NW, SUITE 700, WASHINGTON, DC, 20036-2680, US

(21) Appl. No.: 10/731,006

(22) Filed: Dec. 10, 2003

(30) Foreign Application Priority Data
Dec. 20, 2002 (JP) 2002-370212

(51) Int. Cl. F16D 33/00

(52) U.S. Cl. 60/345

(57) ABSTRACT

A torque converter having an improved capacity coefficient at high-speed ratios is provided. An impeller 11, a turbine 12, and a stator 13 constitute a torus. The torus rotates about a rotational axis O-O. The impeller 11, turbine 12, and stator 13 each have blades 22, 32, and 42. Furthermore, the radius R1 of the impeller inflow part 22a, i.e., the distance between the radially inside end part of the impeller blades 22 and the rotational axis, is smaller than the radius R2 of the stator inflow/outflow part 42a, i.e., the distance between the radially inside end parts of the stator blades 42 and the rotational axis.

### BACKGROUND OF THE INVENTION

1. Field of the Invention

The present invention relates to a torque converter. More specifically, the present invention relates to a torque converter having an improved capacity coefficient at high-speed ratios.

2. Background Information

A conventional torque converter is a device that has a torus having three bladed wheels (an impeller, a turbine, and a stator) and is configured to transmit power using a fluid disposed inside the torus. The impeller and the front cover form a fluid chamber that is filled with operating oil. The impeller chiefly has an annular impeller shell, a plurality of impeller blades fixed to the inside of the impeller shell, and an annular impeller core fixed to the inside of the impeller blades. The turbine is arranged inside the fluid chamber such that it faces opposite the impeller along the axial direction. The turbine chiefly has an annular turbine shell, a plurality of turbine blades fixed to the surface of the turbine shell that faces the impeller, and an annular turbine core fixed to the inside of the turbine blades. An inner circumferential part of the turbine shell is fixed to a flange of a turbine hub with a plurality of rivets. The turbine hub is coupled to an input shaft such that it cannot rotate relative to the input shaft. The stator is a mechanism serving to redirect the flow of the operating oil returning to the impeller from the turbine and is arranged between an inner circumferential part of the impeller and an inner circumferential part of the turbine. The stator chiefly includes an annular stator shell, a plurality of stator blades provided on the outer circumferential surface of the stator shell, and an annular stator core fixed to the tips of the stator blades. The stator shell is supported on a stationary shaft through a one-way clutch.

A coefficient that expresses the performance of the torque converter is the capacity coefficient C, which is given by Equation (1) below.

C=T₁/n₁² (1)

The capacity coefficient C indicates the relationship between the rotational speed n₁ of the impeller of the torque converter and the torque T₁ delivered to the impeller of the torque converter and expresses the torque that can be delivered at a given rotational speed. As the equation indicates, assuming the rotational speed n₁ of the impeller of the torque converter (i.e., the rotational speed of the engine) is the same, the torque T₁ that can be delivered to the torque converter is larger when the capacity coefficient C is larger. This also means that, assuming the rotational speed n₁ of the impeller of the torque converter is the same, the load on the engine is larger when the capacity coefficient C is larger. The capacity coefficient C is larger in regions where the speed ratio (i.e., the ratio of the turbine rotation speed to the impeller rotational speed) is small, i.e., in the idling region of the engine and regions closely adjacent thereto. Meanwhile, the capacity coefficient C becomes smaller as the speed ratio increases, i.e., as the engine rotational speed increases.

If the torque converter is configured such that the capacity coefficient C is larger at high-speed ratios, the acceleration performance of the vehicle will improve when accelerating from an intermediate speed. Consequently, attempts to increase the capacity coefficient C for the high-speed region have been made as disclosed in Japanese Laid-open Patent Publication 2002-106676, which is hereby incorporated by reference.

As already explained, there is a demand for torque converters having larger capacity coefficients at high speed ratios in order to improve the performance of vehicles.

In view of the above, it will be apparent to those skilled in the art from this disclosure that there exists a need for an improved torque converter. This invention addresses this need in the art as well as other needs, which will become apparent to those skilled in the art from this disclosure.

### SUMMARY OF THE INVENTION

An object of the present invention is to provide a torque converter having an improved capacity coefficient at high-speed ratios.

A torque converter in accordance with a first aspect of the present invention is configured to transmit torque using a fluid and is provided with an impeller, a turbine, and a stator. The impeller forms a fluid chamber with a front cover. The turbine is arranged in the fluid chamber to face the impeller. The stator is arranged between the impeller and the turbine and functions to redirect the flow of fluid flowing from the turbine to the impeller. The impeller, turbine, and stator constitute a torus. The torus is configured to rotate about its axis of symmetry. The impeller, turbine, and stator each have blades. A radius R1 of the impeller inflow part, i.e., the distance between the radially inside end parts of the blades of the impeller and the axis of symmetry, is smaller than a radius R2 of the stator inflow/outflow part, i.e., the distance between the radially inside end parts of the blades of the stator and the axis of symmetry.

The torque converter of the present invention is configured such that the radius R1 of the impeller inflow part is smaller than the radius R2 of the stator inflow/outflow part. In other words, the radially inward facing tips of the impeller blades are positioned more radially inward than in the prior art and the difference between the inside diameter and the outside diameter of the impeller blades is larger than in the prior art. As a result, the energy imparted to the fluid by the impeller blades is larger than in conventional torque converters. Thus, when compared to a conventional torque converter having substantially the same outermost diameter, a torque converter in accordance with the present invention has a larger capacity coefficient at high-speed ratios.

Additionally, in conventional torque converters, the main force acting on the fluid heading toward the impeller from the stator is a radially outward centrifugal force resulting from the rotation of the torus of the torque converter. Conversely, in a torque converter in accordance with the present invention, since the radius R1 of the impeller inflow part is smaller than the radius R2 of the stator inflow/outflow part, the pressure at the radially inside section of the impeller inflow part decreases and a radially inwardly directed force acts on the fluid heading toward the impeller from the stator. If this force is balanced against the centrifugal force, the fluid heading toward the impeller from the stator will flow linearly in a generally axial direction. As a result, the turbulence that can easily occur when the fluid flows from the stator to the impeller is suppressed and the torque converter efficiency is improved.

A torque converter in accordance with a second aspect of the present invention is the torque converter according to the first aspect, wherein the radius R1 of the impeller inflow part and the radius R2 of the stator inflow/outflow part have the following relationship: 0.75≦R1/R2<1.00.

When the radius R1 of the impeller inflow part is smaller than the radius R2 of the stator inflow/outflow part, the pressure of the radially inside section of the impeller inflow part decreases. If the radius R1 of the impeller inflow part is too small, the pressure will decrease too much and cause the radially inward force acting on the fluid heading toward the impeller from the stator to be too strong. As a result, turbulence will occur easily in the fluid flowing from the stator to the impeller.

However, in a torque converter in accordance with the present invention, the ratio of the impeller inflow part radius R1 to the stator inflow/outflow part radius R2 is at least 0.75. As a result, the pressure does not become too low at the radially inside section of the impeller inflow part and the radially inward force acting on the fluid heading from the stator to the impeller does not become too strong. Thus, it is difficult for turbulence to occur in the fluid heading from the stator to the impeller and the efficiency of the torque converter can be kept at a high level.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a vertical cross-sectional schematic view of a torque converter in accordance with a preferred embodiment of the present invention; and

FIG. 2 is a view of a graph of the capacity coefficient, torque ratio, and efficiency of a conventional torque converter and a torque converter in accordance with the preferred embodiment, the white marks indicating values for the conventional torque converter and black marks indicating values for the torque converter of the preferred embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

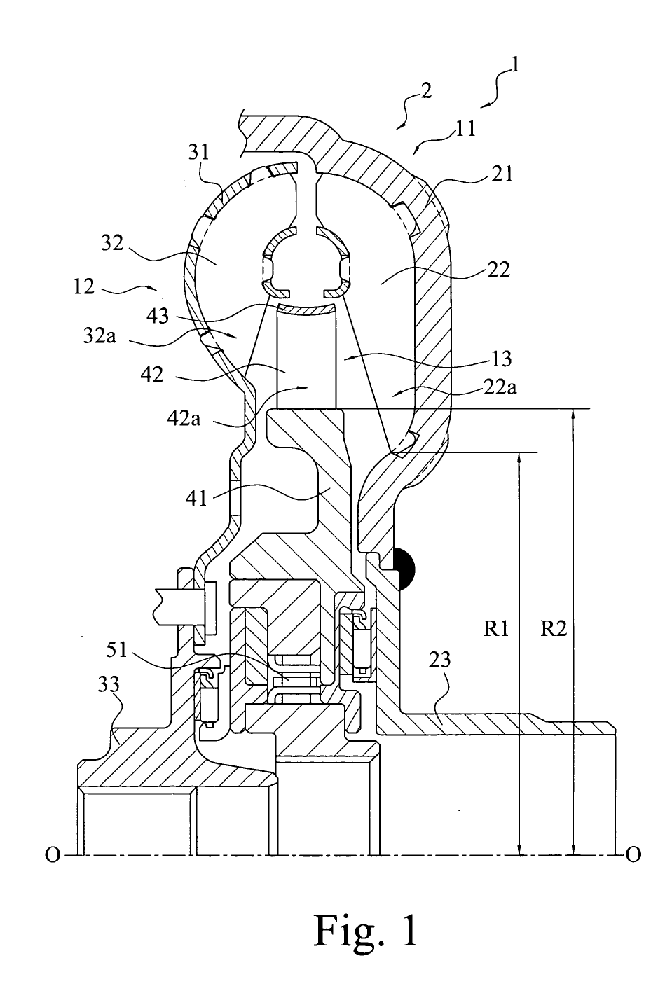

A torque converter 1 in accordance with a preferred embodiment of the present invention is shown in FIG. 1. FIG. 1 is a vertical cross-sectional schematic view of the torque converter 1. The torque converter 1 is a device that serves to transmit torque from the crankshaft of an engine (not shown) to the input shaft of a transmission. The engine (not shown) is disposed on the left side of FIG. 1 and the transmission (not shown) is disposed on the right side of FIG. 1. Line O-O in FIG. 1 is the rotational axis of the torque converter 1.

Overall Constitution

The torque converter 1 has a torus-shaped fluid operating chamber 2 having three bladed wheels, an impeller 11, a turbine 12, and a stator 13.

The impeller 11 chiefly includes an impeller shell 21 that forms a portion of the outside wall of the fluid operating chamber 2, a plurality of impeller blades 22 fixed to the inside of the impeller shell 21, and an impeller hub 23 fixed to the radially inside portion of the impeller shell 21. The impeller hub 23 may be integrally formed with the impeller shell 21. The impeller inflow part 22a, i.e., the radially inside portion of the impeller blades 22, serves to receive the inflow of operating oil that has passed through the turbine 12 and the stator 13. The crankshaft and the impeller shell 21 are connected together with a flexible plate and other components (not shown) such that torque is transmitted from the crankshaft to the impeller shell 21.

The turbine 12 is arranged to face axially the impeller 11 along a direction parallel to the rotational axis inside the fluid operating chamber 2. The turbine 12 chiefly has a turbine shell 31, a plurality of turbine blades 32 fixed to the side of the turbine shell 31 that faces the impeller 11, and a turbine hub 33 fixed to a radially inward part of the turbine shell 31. The turbine outflow part 32a, i.e., the radially inside portion of the turbine blades 32, is the portion where the operating oil that has passed through the turbine 12 passes through the stator 13 and flows out into the impeller inflow part 22a. The turbine hub 33 rotates integrally with an input shaft of a transmission (not shown in the Figures). As a result, the torque of the turbine 12 is transmitted to the transmission.

The stator 13 is axially disposed between an inner circumferential portion of the impeller 11 and an inner circumferential portion of the turbine 12 and serves to redirect the flow of the operating oil returning to the impeller 11 from the turbine 12. The stator 13 chiefly includes an annular stator shell 41, a plurality of stator blades 42 provided on the outer circumferential surface of the stator shell 41, and an annular stator core 43 fixed to the tip ends of the stator blades 42. The stator blades 42 are fixed to an outer circumferential surface of the stator shell 41 at the radially inwardly facing tips thereof. The stator shell 41 is supported on a stationary shaft (not shown in the figures) through a one-way clutch 51. The stator inflow/outflow part 42a is a portion through which the operating oil passes as it returns to the impeller 11 from the turbine 12.

The radius R1 of the impeller inflow part 22a is preferably smaller than the radius R2 of the stator inflow/outflow part 42a. The radius R1 of the impeller inflow part 22a is the radial distance between the radially inside end parts of the impeller blades 22 (i.e., innermost rim of the impeller inflow part 22a) and the rotational axis O-O of the torque converter 1. The radius R2 of the stator inflow/outflow part 42a is the radial distance between the radially inside end parts of the stator blades 42, i.e., the outer circumferential surface of the stator shell 41 (innermost rim of stator inflow/outflow part 42a), and the rotational axis as shown in FIG. 1. The relationship between the impeller inflow part radius R1 and the stator inflow/outflow part radius R2 in this embodiment is preferably R1/R2=0.9.

A torus-shaped fluid operating chamber 2 is preferably formed by the shells 21, 31, 41 of the bladed wheels 11, 12, 13. Although the one-way clutch 51 shown in FIG. 1 uses sprags, a clutch structure that uses rollers or a ratchet is also acceptable.

Operation of the Torque Converter

The transmission of torque from the impeller 11 to the turbine 12 is accomplished by the fluid drive of the operating oil flowing between the impeller 11 and the turbine 12. The operating oil that flows from the impeller 11 to the turbine 12 rotates the turbine 12 and then returns to the impeller 11 through the stator 13.

A torque converter 1 in accordance with an embodiment of the present invention is configured such that the radius R1 of the impeller inflow part is smaller than the radius R2 of the stator inflow/outflow part (see FIG. 1). As a result, the torque converter 1 has the following characteristics.

(1)

In torque converters of the prior art, the radius R1 of the impeller inflow part and the radius R2 of the stator inflow/outflow part are almost the same or the radius R1 of the impeller inflow part is larger than the radius R2 of the stator inflow/outflow part. Conversely, the torque converter 1 of the present invention is configured such that the radius R1 of the impeller inflow part is preferably smaller than the radius R2 of the stator inflow/outflow part. In other words, the radially inside ends of the impeller blades 22 are positioned more radially inward than in the torque converters of the prior art. As a result, the difference between the inside diameter and the outside diameter of the impeller blades 22 is larger than in the prior art, i.e., the radial length of the impeller blades 22 is larger than the impeller blades of the prior art. Thus, the energy imparted to the fluid by the impeller blades 22 is larger than in the torque converters of the prior art and the torque transmitted to the turbine 12 from the impeller 11 is larger than in the prior art. In short, when compared to a conventional torque converter having substantially the same outermost diameter, a torque converter in accordance with the present invention has a larger capacity coefficient at high-speed ratios.

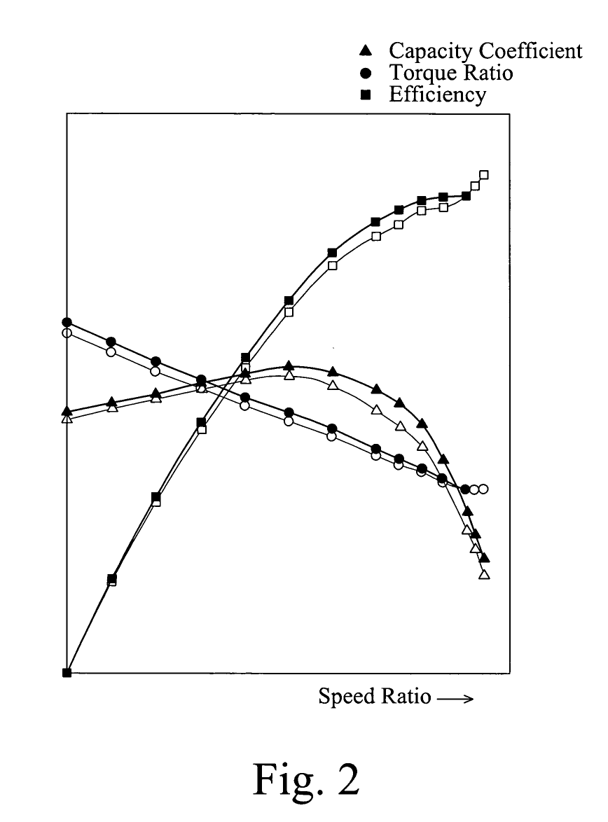

FIG. 2 shows the results of measurements of the capacity coefficient, torque ratio, and efficiency versus the speed ratio for a conventional torque converter and for the torque converter 1 of this embodiment. The capacity coefficient, torque ratio, and efficiency are indicated with triangles, circles, and squares, respectively. Values for the conventional torque converter are indicated with white marks and values for the torque converter of this embodiment are indicated with solid black marks.

As FIG. 2 clearly indicates, the capacity coefficient of the torque converter 1 of the embodiment is larger than that of the conventional torque converter, particularly at high-speed ratios.

(2)

In a torque converter 1 in accordance with the present invention, since the radius R1 of the impeller inflow part is smaller than the radius R2 of the stator inflow/outflow part, the pressure at the radially inside section of the impeller inflow part 22a decreases and a suction force directed radially inwardly acts on the fluid heading toward the impeller 11 from the stator 13. If this suction force is balanced against the centrifugal force, the fluid heading toward the impeller 11 from the stator 13 will flow linearly in a generally axial direction. Thus, the turbulence that can easily occur when the fluid flows from the stator 13 to the impeller 11 is suppressed and a flow of operating oil that is close to that intended by the design of the torque converter 1 can be achieved. As a result, the efficiency of the torque converter 1 is improved.

As indicated by the square marks in FIG. 2, the efficiency values of the torque converter 1 of the embodiment are higher than those of the conventional torque converter over substantially the entire range.

If the radius R1 of the impeller inflow part is too small, the suction force acting radially inwardly on the fluid heading toward the impeller 11 from the stator 13 will be too strong. Thus, it is desirable for the radius R1 of the impeller inflow part to be an appropriate size in relation to the radius R2 of the stator inflow/outflow part. In a torque converter 1 in accordance with the present invention, the ratio of the impeller inflow part radius R1 to the stator inflow/outflow part radius R2 is at least 0.75. As a result, the pressure does not become too low at the radially inside section of the impeller inflow part 22a and the radially inward force acting on the fluid heading from the stator 13 to the impeller 11 does not become too high. Thus, it is difficult for turbulence to occur in the fluid heading from the stator 13 to the impeller 11. In other words, the fluid flowing from the stator 13 to the impeller 11 flows substantially linearly along an axial direction. As a result, the torque transmission efficiency of the torque converter 1 can be kept at a high level.

The present invention is not limited to the embodiment described heretofore; a variety of modifications and revisions can be made without deviating from the scope of the invention. For example, any of a variety of lockup devices can be installed on the engine side of the turbine.

Effects of the Invention

The present invention has the effect of increasing the capacity coefficient of a torque converter at high-speed ratios.

As used herein, the following directional terms “forward, rearward, above, downward, vertical, horizontal, below, and transverse” as well as any other similar directional terms refer to those directions of a vehicle equipped with the present invention. Accordingly, these terms, as utilized to describe the present invention should be interpreted relative to a vehicle equipped with the present invention.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

This application claims priority to Japanese Patent Application No. 2002-370212. The entire disclosure of Japanese Patent Application No. 2002-370212 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A torque converter that transmits torque using a fluid comprising:
an axis of rotation;
a fluid chamber comprising an impeller having impeller blades, said impeller having a first radius being the distance a radially inside end of said impeller blades and said axis of rotation;
a turbine having turbine blades, said turbine being arranged in said fluid chamber to face axially said impeller; and
a stator having stator blades, said stator being arranged between said impeller and said turbine, said stator having a second radius being the distance a radially inside end of said stator blades and said axis of rotation, said first radius being smaller than said second radius.

2. The torque converter according to claim 1, wherein a ratio of said first radius R1 divided by said second radius R2 is greater than or equal to 0.75.

3. The torque converter according to claim 2, wherein said stator further comprises a one-way clutch.

4. The torque converter according to claim 3, wherein a ratio of said first radius R1 divided by said second radius R2 is 0.9.

5. The torque converter according to claim 2, wherein a ratio of said first radius R1 divided by said second radius R2 is 0.9.

6. The torque converter according to claim 1, wherein said stator further comprises a one-way clutch.

7. The torque converter according to claim 6, wherein a ratio of said first radius R1 divided by said second radius R2 is 0.9.

8. The torque converter according to claim 1, wherein a ratio of said first radius R1 divided by said second radius R2 is 0.9.
